(19) United States
(12) Patent Application Publication
(10) Pub. No.: US 2005/0006809 A1
(43) Pub. Date: Jan. 13, 2005

(54) Processing for producing a covering of an elastomer material and intermediate product thereof

(75) Inventor: Fernando Stroppiana, Grinzane Cavour (IT)

Correspondence Address: SEED INTELLECTUAL PROPERTY LAW GROUP PLLC, 701 FIFTH AVE, SUITE 6300, SEATTLE, WA, 98104-7092, US

(73) Assignee: Mondo S.p.A., Gallo d'Alba (IT)

(21) Appl. No.: 10/637,845

(22) Filed: Aug. 7, 2003

(30) Foreign Application Priority Data
Aug. 13, 2002 (EM) 02425525.9

(51) Int. Cl. B29C 35/00

(52) U.S. Cl. 264/141; 264/175; 264/349; 428/542.8

(57) ABSTRACT

The process aims at providing a covering, such as a flooring, that has an appearance substantially free from phenomena of directionality, starting from a vulcanizable elastomer material, the said process comprising the operations of: feeding an extruder with strips of vulcanizable elastomer material of different color, subjecting said material to extrusion, causing it to pass through a drawplate provided with openings; subjecting to shredding the material obtained by means of drawing so as to obtain, as a result of the action of shredding, a granular material; subjecting said granular material to mixing until it is rendered substantially homogeneous; feeding said granular material rendered homogeneous by mixing to a calender, by direct feeding by gravity of the homogeneous granular material into the gap between the rollers of the calender so as to obtain, as a result of calendering, a strip of vulcanizable elastomer material; and subjecting said material in the form of a strip to vulcanization. The aforesaid granular material rendered homogeneous constitutes the intermediate product of the process.

### FIELD OF THE INVENTION

The present invention relates to the production of coverings, for instance floorings made of elastomer material, such as rubber.

### BACKGROUND OF THE INVENTION

The present invention belongs in the line of solutions oriented towards providing coverings of the type described, preventing them from presenting characteristics of directionality, above all as regards the aesthetic appearance of the covering.

For example, the patent No. EP-A-0 968 804, in the name of the present applicant, describes a process for producing a covering comprising at least one layer made of a rubber-based material of a cohesive type. The process comprises the steps of forming a substantially continuous bed of the aforesaid fragmented material and the operation of subjecting the material of said bed to a process of compacting so as to form a sheet material as a result of the cohesion of the material. The aforesaid compacting operation is carried out substantially in the absence of stresses due to stretching exerted on the fragmented material. This result is obtained, for instance, by using an isostatic press or a pair of belt-type elements having branches that face one another to define a compacting chamber.

The patent No. EP-B-0 512 197 describes a process for producing —continuously—a flooring made of curable (i.e., vulcanizable) elastomeric material starting from shaped pieces of a number of colors produced and compressed one against the other by application of heat and pressure so as to form a homogeneous strip. The solution described in EP-B-0 512 197 envisages the use, for making the above-mentioned pieces consisting of a number of colors, of a short-screw extruder (with a ratio of screw length/screw diameter of from 4:1 to 10:1) loaded in a continuous way at an operating temperature of 60-100° C. with two or more strips of vulcanizable elastomer material of different color. The above process also envisages adjustment of the extrusion rate of the extruder in such a way as not to give rise to mixing of the colors of the strips that are fed through the extruder.

At output from the extruder, the elastomer material is fed through a drawplate provided with cylindrical holes, and the filiform material resulting from the drawing operation is cut so as to give rise to pieces having a length of 1-2 mm. These pieces are then dropped directly into the gap of a two-roll calender, the rollers of which have a diameter/length ratio that is precisely determined (1:3.5) and are heated to a surface temperature of between 60° C. and 100° C. The material deriving from the calendering operation is then fed to a continuously operating vulcanization plant so as to obtain a final curing at a temperature of from 160° C. to 180° C.

A basically similar solution is described in EP-A-0 740 154, where, however, the pieces of material deriving from the extrusion and cutting operations prior to being fed into the calender are made to advance on a conveyor for cooling to room temperature, the said conveyor having a length of 4 to 6 meters.

### BRIEF SUMMARY OF THE PRESENT INVENTION

A drawback of the solutions described in the latter two documents referred to above, which are based on an intrinsically continuous process, is represented by the difficulty of ensuring that the overall color of the covering will remain constant throughout the fabrication process and will not be subject to color change. The phenomenon of color change is a highly negative one when successive portions of the same lot of covering have to be laid one alongside another, with the risk that they will have colors that are even quite different from one another.

The purpose of the present invention is to provide a solution capable of overcoming the said drawback. According to the present invention, this purpose is achieved thanks to a process having the characteristics called for specifically in the claims that follow.

The invention also regards the corresponding intermediate product.

The solution according to the invention is based, in general terms, upon the same operations (extrusion, drawing, shredding, calendering, and vulcanization) implemented in some of the solutions according to the known art, to which reference has been made previously.

There are, however, some significant differences, the most important of which being represented by the fact that the process according to the invention does not present any absolute need for being carried out continuously.

The solution according to the invention envisages that the granular material obtained as a result of the operations of extrusion, drawing and cutting will undergo, prior to being fed into the calender for formation of the material in a strip or ribbon, an operation of mixing. In a preferred way, the said mixing operation is carried out on a sufficiently extensive batch of granular material, for instance, the batch of granular material that is to be used for producing an entire lot of covering strip, the aim being to ensure, precisely as a result of the mixing operations, that the mixed granular material, which constitutes the intermediate product of the process according to the invention and is to be fed into the calender, will present characteristics of complete chromatic homogeneity. This enables assurance of the absolute constancy of the chromatic characteristics of the end product, without any undesirable phenomena of color change or variation.

### BRIEF DESCRIPTION OF THE DRAWINGS

The invention will now be described, by way of example only, with reference to the annexed figures of drawings, wherein:

FIG. 1 is a functional block diagram of an installation for carrying out the process described herein; and

FIG. 2 is a front view of a drawplate adapted for use in such a process.

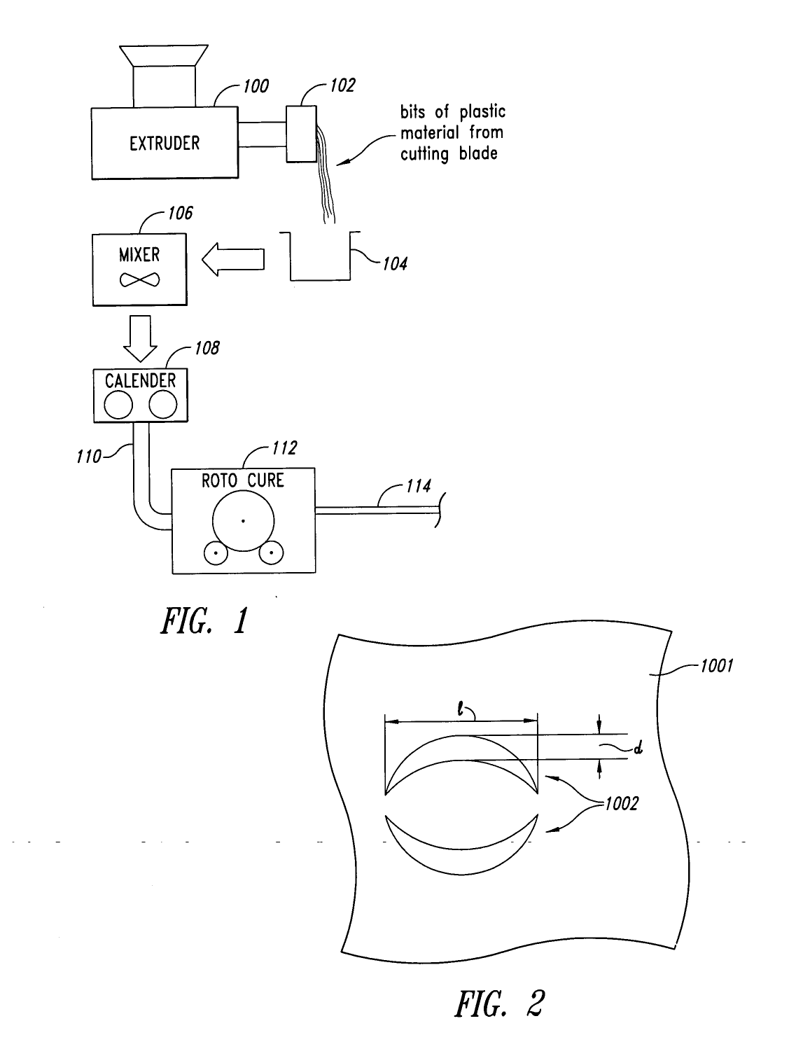

### DETAILED DESCRIPTION OF THE INVENTION

Precisely for the above-mentioned reason, the first step of the process according to the invention, i.e., the treatment in the extruder 100 of strips of different color of vulcanizable elastomer material, such as rubber, does not impose any particular constraints, either as regards the characteristics of the extruder 100, which may be any commercially available extruder, with any length/diameter ratio, or as regards the extrusion rate at which the extruder itself is operated, or again as regards the working temperature, which, without any problem, can be lower than 60° C.

In particular, the solution according to the invention does not impose any constraint as regards the need to prevent, during treatment in the extruder 100, the possible mixing between the colors of strings or strips of different color fed into the extruder. Indeed, in the solution according to the invention an at least partial mixing constitutes a far from undesirable phenomenon.

As far as the operation of drawing is concerned, the tests conducted by the present applicant lead to the conclusion that the use of a drawplate 1001 having holes 1002 as shown in FIG. 2, i.e., of a shape other than the cylindrical one is to be preferred.

Preferably, the aforesaid holes will be crescent-shaped, with a maximum opening or span (i.e., transverse dimension) d of typically between 1 mm and 5 mm, with a preferred value of 2.5 mm and a length I in the region of 10-15 mm.

Of course, all the quantitative values indicated in the foregoing description and appearing in the ensuing claims are to be interpreted, taking into account the tolerances inherent in their execution and in their determination.

Preferably, the aforesaid crescent-shaped openings are arranged in pairs of openings facing one another with opposed concavity, i.e., according to a general configuration ( ) the pairs of openings being distributed in a regular array on the development of the drawplate.

The filiform formations deriving from the passage of the material undergoing extrusion through the holes of the drawplate undergo cutting with a circular blade 102 of a known type so as to form the bits of plastic material that are to be vulcanized, which generally present a marbled appearance and have a length (i.e., a thickness) of typically between 1 and 4 mm.

The particulate material thus obtained is collected and can then be loaded into containers 104, such as drums, bins or tanks, for example, in view of (at least) temporary storage in a collection area or warehouse.

It is evident that, as a result of the collection and storage, the above-mentioned granular material, even though brought up to a certain temperature at the moment of cutting, in any case reaches normal room temperature.

Before and/or after storage (which is in any case optional) and prior to feeding of the material into the calender, which will be described in greater detail hereinafter, the aforesaid particulate material undergoes mixing.

The above result can be achieved using any mixer for granular material, such as for instance a mixer 106 for granules of resin of the plough-mixer or paddle-wheel-mixer type. Mixers of this type are currently available on the market both in the vertical version and in the horizontal version.

As a result of the aforementioned mixing, the granular material assumes an essentially homogeneous appearance, the degree of homogeneity being of course the higher, the more extensive the mixing, this being true even though, in the course of the extrusion process, the characteristics of the vulcanized and extruded material may be changed as a result, for example, as a result of a variation in the coloring of the strips of material fed into the extruder, or else on account of the change in the dimensions of the strips themselves.

The mixed granular material (with or without it being stored), which makes up the intermediate product of the process according to the invention is fed into a calender 108 with counter-rotating rollers.

In a particularly preferred way, feed of the material takes place by gravity through a dispensing device (of a known type) configured for dropping of the particulate material into the gap defined by the two rollers of the calender, which have a horizontal axis and turn in opposite directions, the aim being to impart on the granular material subjected to compression between the two rollers of the calender a general downward movement, which brings about the formation of a continuous strip 110 of compressed vulcanizable material starting from the granular material.

Usually, the calendering treatment is carried out at a temperature just above room temperature (typically between 30° C. and 40° C.), hence with a supply of heat, and consequently an energy consumption, that is extremely contained.

The speed of rotation of the rollers of the calender and the rate of feed by dropping of the granular material onto the rollers are jointly regulated in such a way that there remains a constant level of granular material waiting to be compressed above the gap between the two rollers.

The tests conducted by the present applicant show that with a simple solution of this sort it is possible to obtain a material in the form of a strip that is substantially free from phenomena of directionality of appearance, which are, instead, characteristic of many products obtained by calendering.

The above advantages are achieved without imposing any particular constraint either on the dimensional characteristics of the equipment used (ratio between diameter/length of the extruder or of the rollers of the calender) or on the corresponding operating parameters (feed rate, temperature, etc.).

The material in the form of a strip that comes out of the calendering process can then be fed into a normal continuously operating vulcanization plant 112 (for instance, of the type known by the commercial name Rotocure), in which the step of final vulcanization of the rubber material is carried out.

The resultant vulcanized material 114 already normally presents at least as regards the visual appearance the characteristics of a finished product.

Of course, without prejudice to the principle of the invention, the details of implementation, construction and the embodiments may vary widely with respect to what is described and illustrated herein merely by way of example, without thereby departing from the scope of the present invention as defined in the ensuing claims.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

1. A process for producing, starting from a vulcanizable elastomer material, a covering that has an appearance substantially free from phenomena of directionality, comprising the operations of:
feeding an extruder with strips of vulcanizable elastomer material of different colors, subjecting said material to extrusion by causing it to pass through a drawplate provided with openings;
subjecting the material obtained by means of drawing to shredding so as to obtain, as a result of the action of shredding, a granular material;
subjecting said granular material to mixing until it is rendered substantially homogeneous;
feeding said granular material rendered homogeneous by mixing to a calender, by direct feeding by gravity of the homogeneous granular material into the gap between the rollers of the calender so as to obtain, as a result of calendering, a strip of vulcanizable elastomer material; and
subjecting said material in the form of a strip to vulcanization.

2. The process according to claim 1, comprising the operation of subjecting to storage said granular material before or after said mixing.

3. The process according to claim 1 wherein the drawplate has openings having a crescent-shaped conformation.

4. The process according to claim 3 wherein said openings have a maximum transverse dimension of between 1 mm and 5 mm.

5. The process according to claim 3 wherein said openings have a maximum transverse dimension of 2.5 mm.

6. The process according to claim 3 wherein said openings have a length in the region of 10-15 mm.

7. The process according to claim 3 wherein said crescent-shaped openings are arranged in pairs of openings facing one another with the concavity set opposed, i.e., according to a general configuration ( ).

8. The process according to claim 7 wherein said pairs of openings are distributed according to a regular array on the development of the drawplate.

9. The process according to claim 1, comprising the operation of enabling said granular material to reach, before or after said mixing operation, room temperature.

10. The process according to claim 1, comprising the operation of enabling an at least partial mixing of the colors of said strips of vulcanizable elastomer material fed to the extruder.

11. The process according to claim 1 wherein the rollers of said calender are kept at a temperature of substantially between 30° C. and 40° C.

12. The process according to claim 1 wherein the speed of rotation of the rollers of the calender and the rate of feed by gravity of the granular material onto the rollers are regulated jointly so as to maintain a constant level of granular material waiting to be calendered.

13. An intermediate product of the process according to claim 1 wherein said intermediate product is constituted by said granular material that has been rendered substantially homogeneous.
